(19) United States
(12) Patent Application Publication
(10) Pub. No.: US 2023/0302306 A1
(43) Pub. Date: Sep. 28, 2023

(54) FACIAL GUARD SYSTEM

(71) Applicant: David T.W. Chiu, Tuxedo Park, NY (US)

(72) Inventor: David T.W. Chiu, Tuxedo Park, NY (US)

(21) Appl. No.: 18/320,139

(22) Filed: May 18, 2023

Related U.S. Application Data
(63) Continuation of application No. 17/481,283, filed on Sep. 21, 2021.
(60) Provisional application No. 63/182,411, filed on Apr. 30, 2021.
(60) Provisional application No. 63/081,097, filed on Sep. 21, 2020.

(51) Int. Cl. A62B 18/02; A62B 18/08; A62B 18/00

(52) U.S. Cl. CPC A62B 18/02; A62B 18/084; A62B 18/006

(57) ABSTRACT

A facial guard system configured to be worn on a person's head, in front of the face, has a barrier with a peripheral edge that cooperates with a base that acts as a seal between the barrier and the person's face to create an enclosed space around the facial orifices into which air may flow into only through a submaxillary filtered opening and one or more additional filtered openings defined in the barrier and/or base. The base includes a conforming section that creates a continuous seal across the wearer's forehead, down along the zygoma, cheek, and jaw on each side of the wearer's face, and then to or under the wearer's chin. The submaxillary filtered opening may include an integrated filter and fan unit for blowing air into enclosed spaced directed toward the nostrils of a person wearing the facial guard system.

This application claims the benefit U.S. provisional application No. 63/081,097, filed Sep. 21, 2020, and U.S. provisional application No. 63/182,411, filed Apr. 30, 2021, each of which is incorporated herein by reference in its entirety for all purposes.

### FIELD OF INVENTION

The application pertains to facial guards worn over the face of a person.

### BACKGROUND

Masks over the mouth and nose are used to slow the transmission through oral and nasal mucous membranes of viruses like the SARS-CoV-2 virus that causes a severe, acute respiratory distress syndrome referred to as COVID-19. The masks are, more generally, used to reduce the inhalation and further spread of airborne pathogens (for example, bacteria and fungus) or other particulates capable of causing irritation, injury, or disease.

There are multitudes of masks available, but only a few function as an effective barrier to viruses while permitting sufficient airflow to breathe. Masks meeting the “N95”, or an equivalent standard, are generally considered to be an effective barrier to the movement of infectious virus particles. The filtering media is capable of filtering 95% of particles having a diameter of 0.3 micrometers or microns. It is made of non-woven fibers that form a dense yet sufficiently porous interface through which air can flow while impeding the passage of viral particles with a diameter of 0.3 micrometers or greater from one side to the other by trapping, or otherwise blocking movement, of most of the particles before they can exit the other side of the media.

Most examples of the masks being used for controlling the spread of viruses are disposable and little more than a filtering media tailored into a snout-like shape that extends over the mouth and nose, which is then pulled tight against the face using straps or loops around the ears. There are several problems with using such masks. Wearing a mask makes it more difficult to breathe, especially masks that are very efficient or effective at filtering small particles, such as those meeting N95 and equivalent standards. Masks also muffle sounds, making it more difficult to hear or understand the person wearing the mask. Not being able to see the wearer's mouth and facial expressions around the mouth compounds this problem, especially for the deaf and hard of hearing community. Furthermore, an additional face shield is required to protect the mucosa of the eyes. Additionally, a mask can irritate or injure the skin on the nose and cheeks when it is drawn tight against the face to create the necessary seal and is worn for extended periods of time.

### SUMMARY

The invention pertains to apparatuses configured to be worn on a person's head, in front of the face, with a barrier that cooperates with the face to create an enclosed space in front of the face, into which air is drawn and out of which air is expelled, and to methods of operation and use of such apparatus.

The apparatus is adapted to create a secure interface with a wearer's face to prevent substantial airflow between the enclosed space and the environment, except through one or more filtered openings. The barrier between the facial orifices and eyes of the wearer of the apparatus and the environment, through which air or liquid cannot flow under expected environmental conditions, seals to the face with an interface surrounding the facial orifices and eyes to create an enclosed environment around the facial orifices that only allows ingress and egress of air through openings defined by the apparatus. In one example, the barrier's peripheral edge cooperates with a base that, when worn, positions the barrier in front of and spaced from the wearer's face from a point above the wearer's eyes to a point at or below the user's mouth. The base creates a seal with the barrier, along its periphery, and a continuous seal with the wearer's face across the wearer's forehead, down along the zygoma, cheek, and jaw on each side of the wearer's face, to or, preferably but optionally, under the wearer's chin. When the base creates a seal with the wearer's face, the combination of the barrier and base defines the enclosed space to allow the control of airflow into and out of the enclosed space except through one or more openings in the apparatus.

In one exemplary embodiment, the apparatus is configured to allow air to flow only into and out of the enclosed space through a filtration system that blocks at least a predetermined percentage of particles entrained in air flows passing through the filtration system of the type for which the protection system is intended to protect against. In one example, the particles are viruses. A representative example of such a filtration system includes one or more openings in the barrier and/or base that are configured to filter the air passing through the openings. Air may be expelled through the same or, optionally, a different filtered opening.

In a representative, nonlimiting example of this embodiment, a first filtered opening is located on the apparatus so that it is positioned in submaxillary position, below the wearer's chin or jaw, when the apparatus is placed on the wearer's face, which allows for movement of air into and out of the closed space through a filter. In another nonlimiting example, another opening is located above the eyes, near the forehead. The openings are located on the apparatus in positions that, when the apparatus is worn in front of the face, do not block the mouth and eyes of the wearer. In this example, the submaxillary filtered opening is intended to function primarily for the ingress of fresh air into the enclosed space, though it may also allow egress of air. The second filtered opening would function primarily as an exit through which air inside the chamber egresses. Additional filtered openings for air exchanging may, optionally, be located along the sides of the apparatus to increase the overall area through which air can be exchanged between the environment and the enclosed space within the apparatus.

In another embodiment, the apparatus may optionally include a battery-operated fan unit mounted an opening in the apparatus to increase the volume of filtered air moving between the environment and the closed chamber. In one representative, nonlimiting example, the fan unit is mounted in a submaxillary filtered opening to blow filtered air into the closed chamber. Optionally, the fan unit is configured and oriented to create a stream or current of air aimed toward a wearer's mouth and nose to improve comfort.

In an alternative embodiment, the apparatus may, optionally, be adapted for treatment of, for example, sleep apnea by connecting it to receive air from a respiratory system and adapting it so that the air from the respiratory system pressurizes the volume of air within the enclosed space, which pressures the oral and nasal airways of the wearer to assist with preventing the airways from collapsing. Because the facial guard can provide a relatively expansive paranasal space that eliminates the need for a mask or nasal nipple, like those currently employed to treat sleep apnea and other types of respiratory systems, the irritation and skin abrasion caused by such masks can be avoided.

The apparatus may also be adapted for use in other applications.

These and other aspects and features are described below in connection with the representative, nonlimiting examples of embodiments of a facial guard apparatus and systems that are illustrated in the accompanying figures.

### BRIEF DESCRIPTION OF THE DRAWINGS

FIG. 1 is a side view of an example of a first representative, nonlimiting embodiment of a facial guard system.

FIG. 2 is a front view of another example of the facial guard system.

FIG. 3 is a side view of yet another example of the facial guard system.

FIG. 4 is a perspective view of an example of a second representative, nonlimiting embodiment of a facial guard system.

FIG. 5 is a side view of another example of the second representative, nonlimiting embodiment of a facial guard system.

FIG. 6 is a front side view of the example of the second representative, nonlimiting embodiment of a facial guard system of FIG. 5.

FIG. 7 is a back side view of the example of the second representative, nonlimiting embodiment of a facial guard system of FIG. 5.

FIG. 8 is a cross-sectional view of the example of the second representative, nonlimiting embodiment of a facial guard system of FIG. 5 when it is being worn by a person (shown in silhouette).

FIG. 9 is a cross-sectional view of the example of the second representative, nonlimiting embodiment of a facial guard system of FIG. 6 taken along section line 9-9.

FIG. 10 is a perspective view of the facial guard system of FIG. 5 that is shown without vents or filtered opening in a facial shield for purposes of showing more clearly an interface between the facial shield and an anchoring platform.

FIG. 11 illustrates a representative, nonlimiting example of a vent for use with the examples of the facial guard systems of FIGS. 5-10, and which may be adapted for use with the facial guard systems of FIGS. 1-3.

FIG. 12 illustrates another representative, nonlimiting example of a vent for use with the examples of the facial guard systems of FIGS. 5-10, and which may be adapted for use with the facial guard systems of FIGS. 1-3.

FIG. 13 illustrates another representative, nonlimiting example of a vent for use with the examples of the facial guard systems of FIGS. 5-10, and which may be adapted for use with the facial guard systems of FIGS. 1-3.

FIG. 14 is a schematic drawing of a representative, nonlimiting example of an integrated fan and filter unit for use as a submaxillary vent in examples of the facial guard systems of FIGS. 5-10, and which may be adapted for use with the facial guard systems of FIGS. 1-3.

FIG. 15 is partial, exploded view of the representative, nonlimiting example of an integrated fan and filter unit of FIG. 14.

FIG. 16 is a top view of the integrated fan and filter unit of FIG. 15.

FIG. 17 is a bottom, perspective view of the integrated fan and filter unit of FIG. 16.

FIG. 18 is a top, perspective view of another representative, nonlimiting example of an integrated fan and filter unit for use as a submaxillary vent in examples of the facial guard systems of FIGS. 5-10, and which may be adapted for use with the facial guard systems of FIGS. 1-3.

### DETAILED DESCRIPTION OF EXEMPLARY EMBODIMENTS

In the following description, like numbers refer to like elements.

Described below in reference to the drawings are representative, nonlimiting embodiments of apparatuses for creating an enclosed space containing a volume of air in front of the face of a person for the purpose of illustrating various aspects and features, including optional features, which can be embodied or used alone or in combination with each other in such an apparatus. A given embodiment or example may be modified or adapted according to a feature disclosed or described in connection another example of the same or different representative embodiment unless it is identified as an alternative to a feature in the embodiment or example. The same reference number refers to the same or a similar element throughout the drawings, though different reference numbers may be used for the same or a similar element in different figures or embodiments.

The apparatus described below, which will be referred to as a facial guard or mask, facial guard system, or a facial orifice protection system, generally comprises a barrier through which air cannot flow. The barrier has a size and shape that when supported a distance in front of a wearer's face by a base, covers or extends in front of the eyes, nose, and mouth of a wearer. The barrier is capable of sealing and being sealed with the base. The base is shaped and configured to seal against the contours of the face. The barrier and base thereby define a closed chamber, or enclosed space, with a wearer's face, the apparatus impeding air exchange between the closed chamber and the environment except through one or more vents that filter air flowing through the vents.

Any of the apparatus described below may, optionally, be made, adapted, configured, or modified to achieve any one or more of the following: a secure barrier between the eyes, nose, and mouth and the outside environment that cannot be avoided by viral particles through the use of an interface with the wearer that creates a secure seal and has appropriate filtering of air to better control viral infiltration; relatively easy airflow in and out; clear facial recognition and expression of appreciation by not obscuring the wearer's countenance; moisture regression or absorption to reduce fogging; secure fitting but easy removal; integrable with a total body barrier system or as a socially pleasing garment/outfit; economically feasible for anyone to buy; inclusion of a viral deactivation zone utilizing light, such UV light; use of hypoallergenic materials; and incorporation of controllable mechanical airflow, temperature, and humidity.

The apparatus can be constructed with a barrier integrated with a base, with one or. However, the frontal screen may, optionally, be flipped up to allow drinking through a straw or eating. The representative examples described below allows the apparatus to be configured for extended use, with filtering media that can be removed and replaced with new filtering media or with filtering media that has been cleaned. Thus, the apparatus is capable of being configured in a manner that reduces waste and the environmental hazards caused by the use of disposable masks.

FIGS. 1 to 3 illustrate representative embodiments of such an apparatus, which is designated for purposes of this description as facial guard system 100. A visor 102 forms a barrier that is supported and positioned by an anchoring platform 104, which is an example of a base, in front of a face 106 of a person wearing the apparatus on the person's head 108. The anchoring platform 104 is shaped to follow the contours of the wearers face 106 when the apparatus is worn as shown, with the base contacting a wearer's face across the wearer's forehead, down the zygoma 110, cheek 112, and jaw 114 on each side of the face 106, and under the chin 116. Though it is preferred that the anchoring platform extend under the wearer's chin when worn, it may optionally come down to but not completely under the wearer's chin when worn. The anchoring platform thus positions the visor in front of the eyes 118, nose 120, and mouth 122 of the wearer.

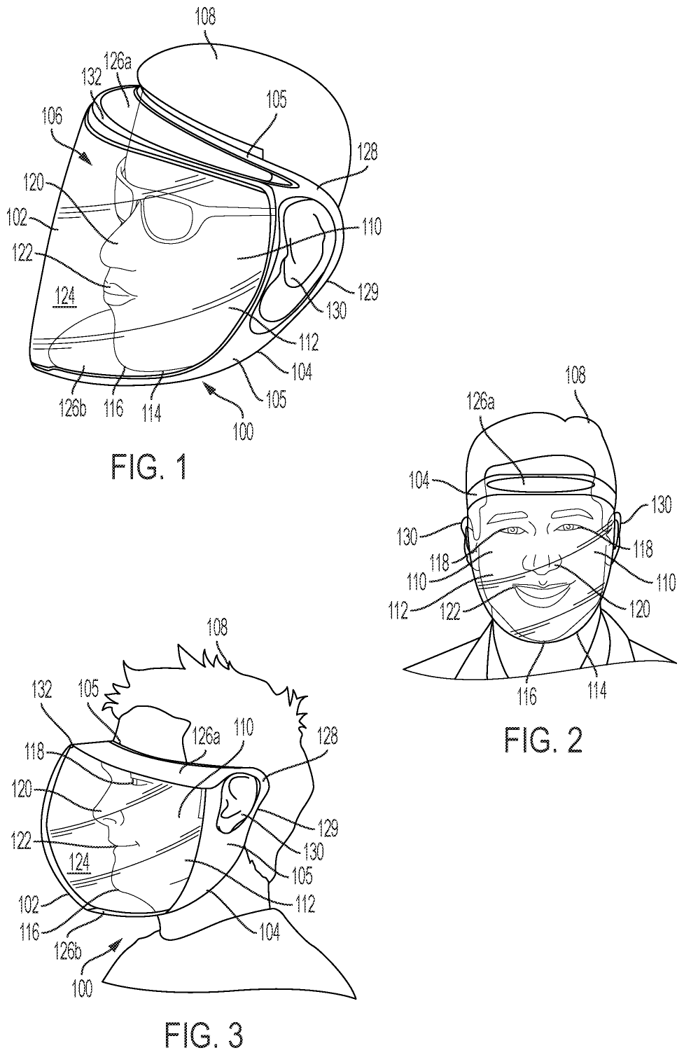

The visor 102 and anchoring platform 104 define a closed chamber 124 (or enclosed space) in front of the wearer's face when the facial guard system 100 is worn that impedes and, under normal operating conditions, substantially blocks airflow into and out of the closed chambered, except through one or more diaphragms made of filtering media suspended or placed across openings in the anchoring platform. The filtering media thus filters all air that ingresses and egresses from the closed chamber 124. The examples of FIGS. 1 to 3 include an upper diaphragm 126a, which functions as a prefrontal filter, and a lower diaphragm 126b, which functions as a submaxillary filter. The embodiments of FIGS. 2 and 3 also include at least one upper diaphragm and a lower diaphragm.

A representative example of anchoring platform 104 comprises a relatively rigid portion 105, an exoskeleton, made of, for example, a relatively hard plastic, rubber, or other material, and a conforming portion for sealing against the wearer's face 106 that is made of a relatively soft and compliant material such as a foam or a soft rubber, such as silicone, or a combination of such materials. The conforming portion adapts or conforms to the contours of the wearer's face, such as through compression, bending, stretching, or a combination thereof, to form a continuous seal with the skin when pressure is applied by the exoskeleton. The conforming portion may, optionally, be resilient, meaning that it tends to return to its original position or shape when removed from the face. The anchoring platform may be made, for example, with a bilaminar structure, with an inner layer of soft, compliant silicone and an outer layer of harder plastic that forms the exoskeleton.

The anchoring platform 104 is pulled against the face and held onto the wearer's head by two hooks 128, each extending behind the wearer's ear 130 and into the retro-auricular recess behind the ear. In this example, each hook loops around the ear, with a back portion 129 laying within the retro-auricular recess. Alternatively, the hooks can form a loop completely encircling each ear. Although not shown, each hook 128 is coupled through, or integrally formed with, an adjustable structure that permits the hooks to be tightened to pull the anchoring platform 104 against the face.

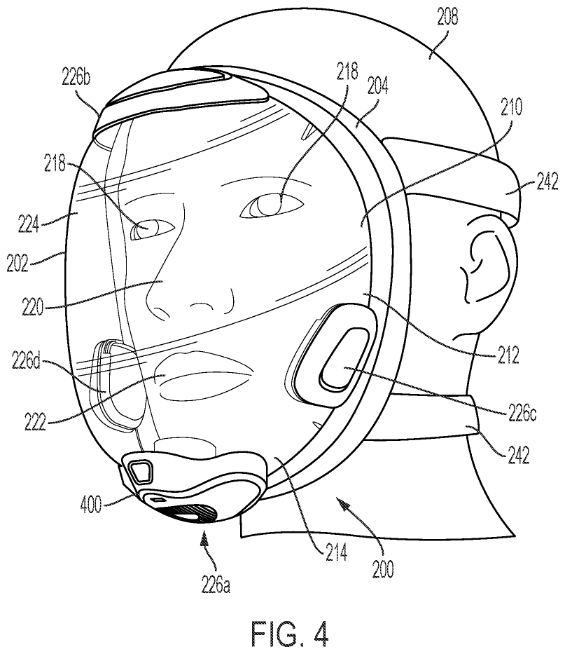

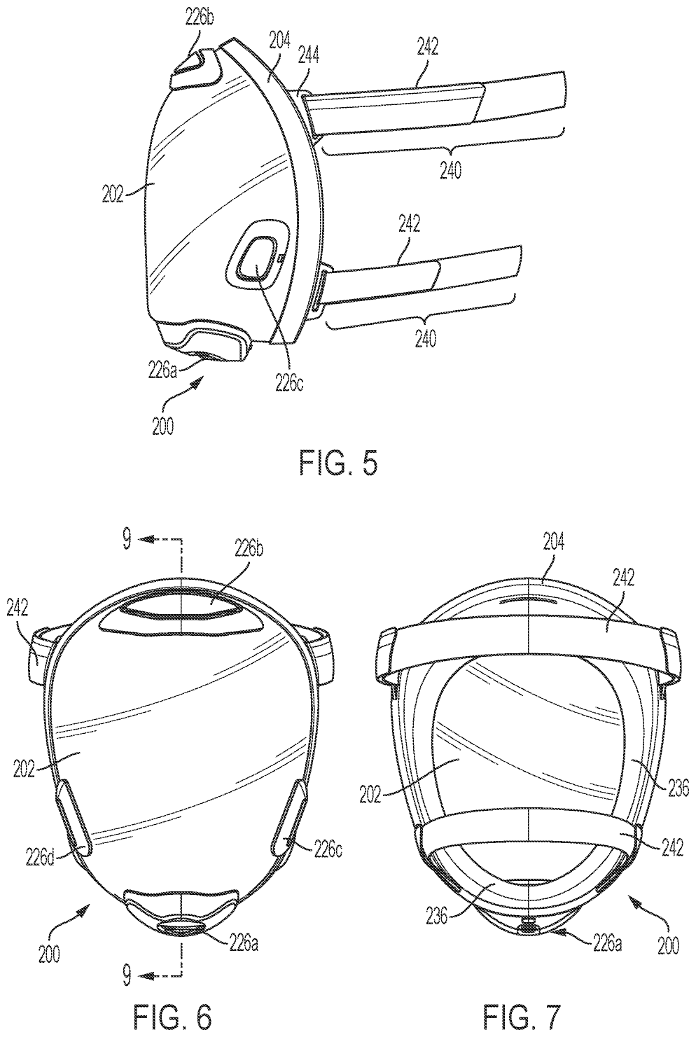

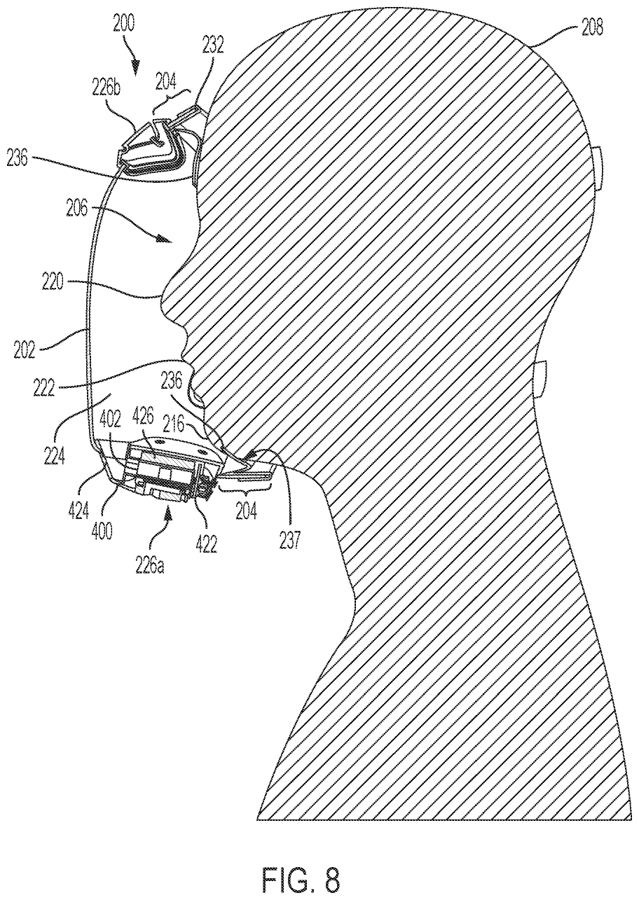

Alternatively, the anchoring platform 104 can be held against the face 106 by a retention system that connects to each side of the anchoring platform, and optionally to the top of the platform, and extends around the back of the user's head. Although not shown in these figures, an example of such a retention system is in the form of straps that extend around the back of the wearer's head is shown in FIGS. 4 to 10.

The visor 102 functions as a frontal screen and can be made of thin plastic with at least a rigid perimeter that coapts, or fits, to an anterior perimeter of the anchoring platform 104 to create a seal that impedes the flow of air between the visor and the anchoring platform. Furthermore, the visor may attach to the base in a fixed position and, optionally, in a manner that permits it to be replaced or removed for the purpose of, for example, cleaning.

As represented only in FIG. 3, the visor 102 may, optionally, be connected so that it is adjustable between opened and closed positions to allow it to be opened to permit eating or, for example, use of a straw to drink without removing the apparatus, and then closed. For example, the facial guard system may include a hemi circular bridge positioned along a frontal forehead bar 132 of the anchoring platform, to which the visor is connected, to allow the visor to be lifted and lowered.

Referring back to FIGS. 1 to 3, the visors 102 in these embodiments are made of transparent plastic. Optionally, the visor can be partially or entirely tinted to reduce or block the transmission of light. When worn by, for example, a healthcare provider, the visor is preferably made of clear, plastic material or lightly tinted in front of the wearer's mouth and eyes to allow them to be seen. For other applications, the visor can also be made in whole or in part of materials that are not translucent.

Referring now to FIGS. 4 to 10, which illustrate representative, nonlimiting examples of another embodiment of a facial guard system, facial guard system 200. Like the representative examples of the facial guard system 100 shown in FIGS. 1 to 3, facial guard system 200 is comprised of a barrier in the form of a visor or shield 202, a base in the form of an anchoring platform 204, and FIGS. 1 to 3 illustrate representative embodiments of such an apparatus, which is designated for purposes of this description as facial guard system 100. The shield 202 forms a barrier to airflow and liquids that is supported and positioned in front of the wearer's face 206 by the anchoring platform 204 when the apparatus is worn on the person's head 208 as shown in FIG. 4.

The anchoring platform 204 is shaped to allow it to conform to the contours of the wearer's face 206 when the apparatus is worn, as shown, with the base contacting the wearer's face 206. When correctly worn, the shield 202 is positioned at a distance in front of the eyes 218, nose 220, and mouth 222 of the wearer.

The shield 202 and anchoring platform 204 define a closed chamber 224 in front of the wearer's face when the facial guard system 200 is worn that impedes and, under normal operating conditions, substantially blocks airflow into and out of the closed chamber, except through one or more vents. In this example, there are four vents: lower or submaxillary vent 226a, an upper or prefrontal vent 226b, a side or lateral vent 226c located to one side of the facial shield, and another side and lateral vent 226d located to the other side of the facial shield. The lateral vents are preferably located to increase the field of view for the wearer and allow for a relatively wide angle of viewing of the wearer's eyes by others. Each vent includes an integrated filter (not visible in these views) that filters the air as it enters or leaves the closed chamber 224. The vents are mounted through openings defined in the shield 202.

The anchoring platform 204 shown in the figures is a representative, nonlimiting example of an anchoring platform having a first portion 230 that cooperates with a peripheral edge 232 of shield 202 to create a mechanical seal and a second or conforming portion 234 that creates a mechanical seal with the wearer's face 206. Pulling the anchoring platform 204 toward the face 206 presses the anchor platform against the face, which in turn presses a sealing surface 237 against the wearer's face 206 along a continuous line that extends across the wearer's forehead and down each side of the face, over the zygoma 210, cheek 212, and jaw 214, and under the chin 216, forming a continuous seal.

The sealing surface 237 is supported in a manner that allows it to be displaced with respect to the first portion 230 (and thus also the shield 202) and bend to orient more of its surface area toward the surface of the skin of the wearer's face 206 for contact with, while also generating a force on, the sealing surface that causes it to conform better to the orientation of to the skin on the face 206, and to press against the face to create a seal that will impede airflow between the anchoring platform and the face. The mechanical seals created by the anchoring platform are capable of substantially blocking the flow of air when the differences in air pressure inside the closed chamber 224, the environment outside the shield 202, and the velocity of any air currents impinging on the seal are within expected ranges when the facial guard is being worn and used as intended.

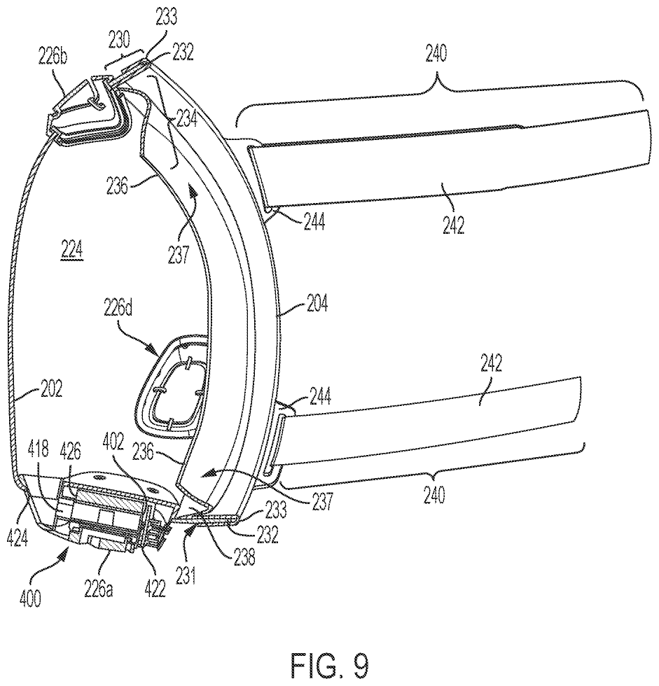

In this example, the first portion 230 has a slot 231 formed by a fold 233 that will function as a seal between the anchoring portion and a peripheral edge portion 232 of the shield 202. This can be seen best in FIG. 9. Due to the material from which the first portion is made and to the geometry of the slot and the part of the shield received within the slot, the inside surfaces of the slot will tend to pinch against the surfaces of the shield 202 that are within the slot 231. The pinching not only improves the quality of the seal but also helps to retain the connection of the shield and the anchoring platform so that they tend not to separate during the normal or intended use of the facial guard. In addition to creating a seal, the part of the shield inserted into the slot also functions to stiffen the first portion 230 and, thus, stiffen and fix the shape of the anchoring platform 204.

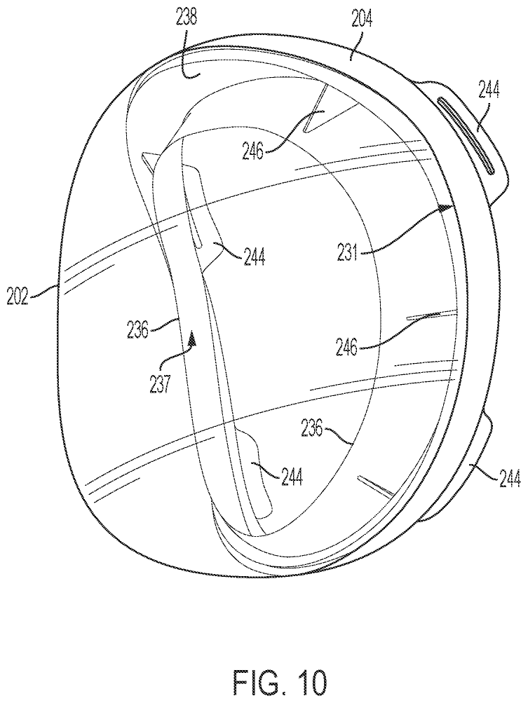

The conforming or second portion 234 includes a flap 236 with a surface 237, a sealing surface, that functions to engage the wearer's skin along the perimeter of the anchoring platform to create a seal. Generally, the greater the area of contact between the sealing surface and skin, the better or more secure the seal will be. The flap connects along a proximate edge to a distal edge of an extension 238 at a fixed, oblique angle with respect to the extension 238. A proximal edge of the extension 238 connects with the first portion 230 at a fixed, oblique angle. Because of the resilient nature of the material from which the flap, the extension, and the first portion are made, a force applied to the sealing surface 237 of the flap will tend to bend or deflect the flap with respect to the extension 238, while also causing the extension to bend or deflect with respect to the first portion 230 (and thus also shield 202), resulting in a displacement of the sealing surface 237 in a direction, generally, toward the first portion and generation of a return force, generally, in the opposition direction, and reorientation of part of the sealing surface along a plane that is normal to the applied force. Thus, when the force being applied is caused by the anchoring platform 204 and the face 206 of the wearer being pulled together, the sealing surface 237 will tend to bend and move inwardly toward the first portion 230, which will reorient the sealing surface to have a greater area of contact while also accommodating variations in distance between the wearer's face and the first portion 230. It will also generate a spring-like force in a direction generally normal to the area of contact with the skin's surface due to the resilient properties of the materials and “Z” shaped structure that will press the sealing surface against the skin. Because of the pliability and resilience of the material, the bending will not cause the structure to deform. The resilience of the material will return the flap and extension 238 to their unloaded, original positions after the anchoring platform is moved away from the face. The conforming portion 234 may include additional elements to achieve the desired geometries, deflections, and force to improve sealing performance. An example is reinforcing ribs 246 for the flap 236, which are shown in FIG. 10. The reinforcing ribs stiffen the flap.

The illustrated structure of conforming portion 234 may also be adapted for use in anchoring platform 104 for the embodiments of facial guard 100.

In this example, the anchoring platform is made from a pliable but resilient material, such as silicone or other soft rubber. It is formed as a unitary component, such as by molding it in a ring or loop shape. However, alternative constructions or substitutes are possible. Representative, nonlimiting examples include molding or extruding one or more lengths of it that are joined, or fabricating multiple, ring-shaped elements that are joined, or a combination of these. This might allow different materials, with different properties, such as hardness and resiliency, or different geometries to be used for the elements of the anchoring system, or a modified structure to be used, which functions similarly to conform the anchoring platform to the wearer's face by compressing a sealing surface and/or conforming it to orient to the surface of the wearer's skin while also generating a return force generally normal to the sealing surface. However, an anchoring platform in which some or all its elements have a unitary construction, made using, for example, a molding process, has fewer, if any, joints, thus reducing or lessening the risk of a gap or leak where the components are joined or failure of the joint.

Alternatively, the conforming portion 234, for example, can be formed using another type of material or a combination of materials arranged. The structure of the conforming portion may have to change based on the properties of the material or materials that are used. Examples of other materials that could be used include foams, gels, rubbers, and the like, and combinations of them that function to conform to the face 206, with or without the resiliency to restore the conforming portion 234 to an original or neutral position.

The anchoring platform 104 is pulled against the face and held onto the wearer's head by an adjustable retention system 240. The adjustable retention system in the illustrated embodiment has two straps 242 that extend around the back of the wearer's head and connect to loops 244 on the anchoring platform. The lengths of the straps are adjustable, and they may also be made of an elastic material to help to ensure that a continual force is applied to the anchoring platform to pull it against the face.

Each of the vents 226b-226d includes a replaceable filter held within an opening formed in the facial shield by an adapter. Vent 226b functions as a prefrontal filter and serves primarily as an egress opening for air within the closed chamber. Vents 226c and 226d also function primarily as exit or egress openings, though air may also be drawn in through the vents by reason because of the proximity to the nose and mouth of the wearer. The vent 226a further incorporates a battery-powered blower or fan for drawing air into the closed chamber and thus services as the primary vent or opening for ingress of air into the closed chamber. It, optionally, may also function to create air circulation within the closed chamber 224 to carry fresh air toward the wearer's mouth and nose.

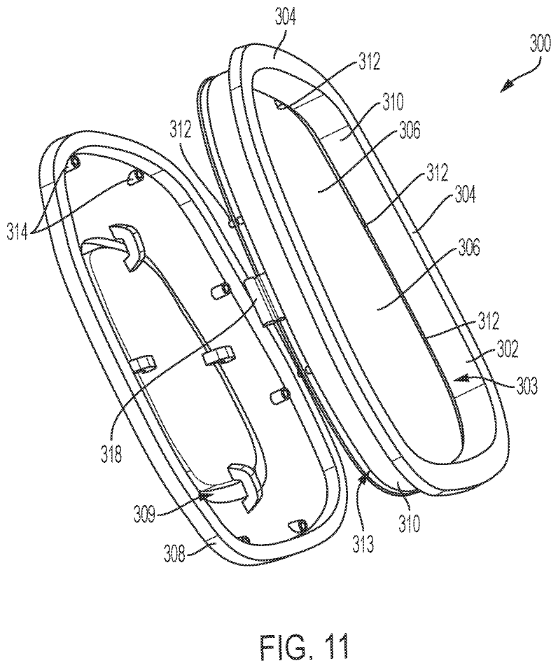

Referring now also to FIGS. 11-13, which illustrate representative, nonlimiting examples of configurations of a vent 300 that can be used or adapted for use as any one or all of the vents 226a-226d of the facial guard system 200. Vent 300 may also be adapted for insertion into one or both of the openings in the anchoring platform 104 (FIGS. 1-3) in place of one of both of the diaphragms 126a and 126b. The examples of vent 300 including a filter in the form of a diaphragm—for example a membrane filter—supported within a structure that functions to create a seal between the edges of the filter and the edges of an opening defined within the barrier and/or base to allow for passage of air into or out of the enclosed space or chamber 124 or 224.

Vent 300 includes an adapter ring 302 that defines an opening 303 and fits with and forms a seal against the edges of an opening in a barrier such as facial shield 202 shown in FIGS. 3-10, or a rigid portion of an anchoring system. The adaptor ring has a flange 304 with an undersurface that sits against an inside surface of a structure that defines the opening to create a seal and prevent the adaptor ring from being pulled through the opening in which it is mounted. Filter media 306 in the form of a diaphragm extends across the opening 303 and is retained by the adapter ring 302 and a cooperating cap 308 that functions to retain the adapter ring within the opening and, optionally, the filtering media 306. It also protects the filtering media from physical harm while providing openings 309 with sufficient cross-sectional area to allow for adequate airflow. A sidewall 310 or rim of the adapter ring 302 defines the opening 303 and extends through an opening in the facial shield 202 of the facial guard system 200. It may also be adapted for use with an opening formed in the anchoring platform 104 to hold a filter diaphragm, such as either or both diaphragms 126a and 126b.

In the example of FIG. 11, the filter media 306 rests on a top edge 313 of the sidewall 310 and is held or anchored by a plurality of pins 312 that extend from the top edge of the sidewall. The pins extend through holes in the filter media that are arrayed around the media near its periphery in positions that align with the pins when the filter is properly oriented and fitted to the adapter ring. The pins also align with sockets 314, formed on the inside of cap 308, which is connected to the sidewall 310 to retain the filter media and ensure that it is sealed against the adapter ring. As an alternative, the position of the pins and sockets could be reversed. Latches 318 extending from the adapter ring 302 deflect when pushed to corresponding openings on the cap 308, allowing a catch or hook to clear. The latch then snaps back to hook onto the cap 308. The latches can be deflected manually to release them from the cap, which allows the cap and adapter ring to be separated for the removal and replacement of the filter. The latch could, alternatively, extend from the cap and engage an opening and latching surface formed on the adaptor ring.

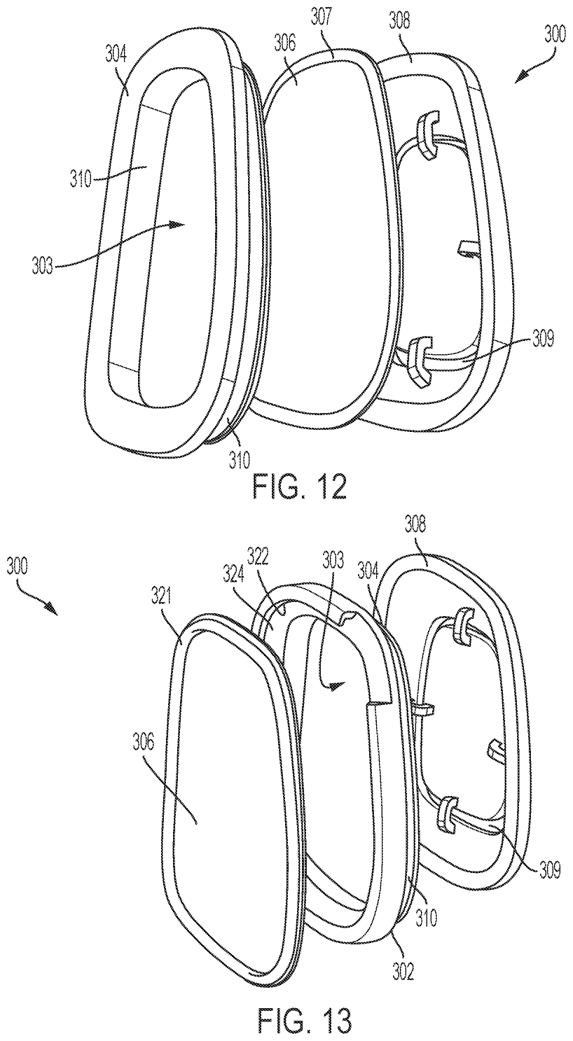

The example of vent 300 show in FIG. 12 is very similar to the one shown in FIG. 11. This example shows the filtering media 306 with an ultrasonically welded and cut edge 307 to facilitate handling of the filtering media during replacement. The filtering media may, optionally, be held within a structure like a frame or a cartridge to make handling and replacement easier.

In the example of vent 300 shown in FIG. 13, the cap 308 and adapter ring 302 are not used to retain the filter media. The filter media is mounted within a rigid frame 321 to facilitate insertion into and retention by a channel 322 formed by the inside surface 320 of flange 304 and flange 324. The frame also helps to establish and maintain sealing contact with the inside surface 320 of flange 304. The sidewall of the adapter ring includes a channel 322 that cooperates with a lip formed around the periphery of cap 308 to retain the cap.

In these examples, the adapter ring can be made with any type of material, such as plastic or rubber. For example, making the ring from a medium-hard rubber and the cap from hard plastic, such as acrylonitrile butadiene styrene (ABS), can provide an effective seal between the filter and the barrier.

An adapter similar to any of these examples could be used to support a filter and create a seal between the filter and the edges of an opening formed within a rigid portion of an anchoring platform, including for example as a replacement for the diaphragms 126a and 126b in the examples of FIGS. 1-3.

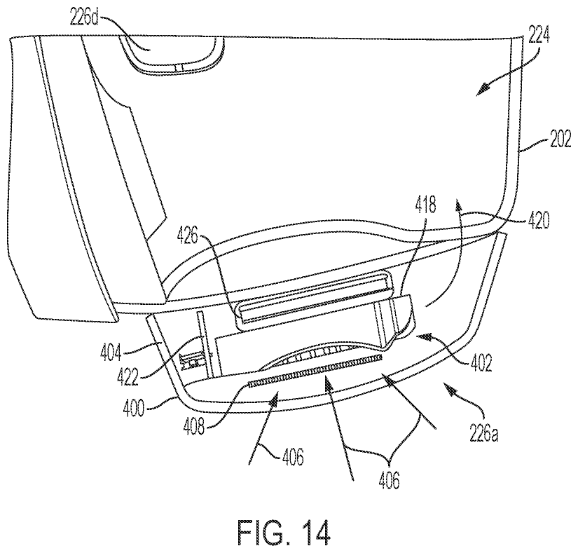

Referring now to FIGS. 14 to 18, in addition to FIGS. 3 to 10, these figures depict an integrated fan and filter unit or assembly 400, which is a representative example of a type of vent that could be adapted for use as filtered opening for facial guard systems 100 and 200. In facial guard system 200, the integrated fan and filter unit 400 unit is employed as the submaxillary vent 226a. It is inserted into or attaches to an opening in the facial shield 202. In the facial guard system 100, described above in connection with the examples of FIGS. 1 to 3, it can be adapted to fit within or be secured to an opening in the anchoring platform 104.

If an integrated fan and filter unit 400 is not used for vent 226a in the facial guard system 200, a vent similar in construction to any of the examples of vent 300 could be adapted for use as vent 226a. The integrated fan and filter unit 400 includes a fan that is set up to push air into the closed chamber 224. Alternatively, the fan could be oriented to draw air from the closed chamber and induce a flow of air into the closed chamber through other vents by decreasing pressure within the closed chamber. Multiple integrated fan and filter units could also be installed in opposing openings, such as the prefrontal and submaxillary openings in facial shield 202, with one of them, preferably the submaxillary unit, set up to direct a stream of filtered, fresh air from outside the facial guard system toward a wearer's nose and a prefrontal unit configured to exhaust to the environment air within the closed chamber.

Representative examples of the types of fans that could be used for an integrated fan and filter unit include axial or centrifugal types of fans. The fan assembly would include the fan mounted within a fan housing, rotated by an electric motor, powered by a battery, with associated control circuitry for controlling power to the motor and, optionally, for controlling the recharging of the battery and other functions and capabilities of the unit.

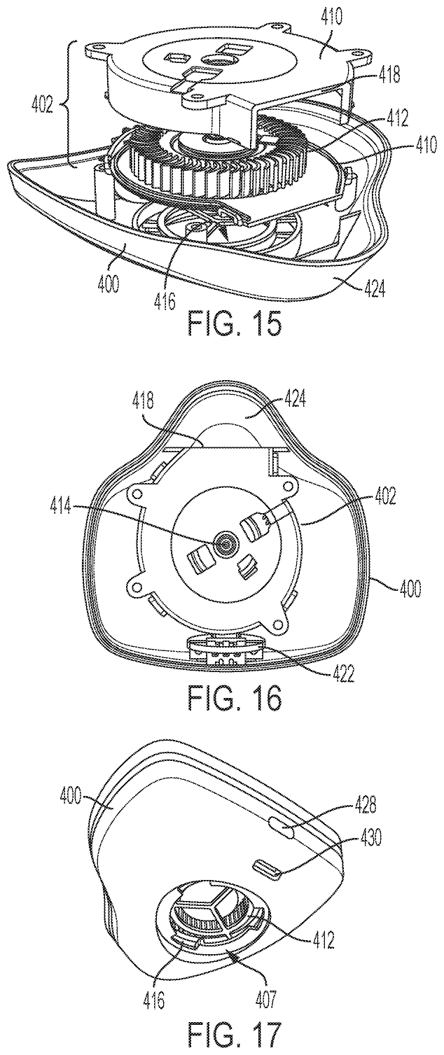

In the examples shown in FIG. 14, which is schematic in nature, and FIGS. 15-17, a centrifugal fan assembly 402 is mounted within a vent housing 404 that includes a fan housing 410, impeller 412, and a motor. The motor, not shown, is attached to a shaft 414, on which the impeller is mounted to rotate. The fan assembly pulls in air, indicated by arrows 406, from the environment, through an opening 407 (not indicated in FIG. 14) in the vent housing 404. The air is drawn through filter 408 (indicated only in FIG. 14), which is placed across an inlet 416 (FIG. 17) to the fan housing 410. As indicated by arrow 420 in FIG. 14, the air exits the fan housing at a higher velocity air stream from fan housing outlet 418. When it exits the fan house, the air stream (arrow 420) is oriented toward a side of the vent housing 404. Part of the vent housing 404 next to the fan housing outlet 418 is configured as a deflector 424 that assists with redirecting the air stream upwardly into the closed chamber 224, toward the wearer's mouth and nose. Alternatively, a baffle, or similar structure, could be placed with the vent housing near the fan outlet to deflect the airstream. When used, the fan increases the amount of fresh air delivered directly for breathing.

Though not shown, the inlet coupled with the housing will receive a cap with airflow openings that cooperates with the inlet opening to support a filter within the inlet, through which the air is forced to flow. The filter is removable for cleaning or replacement. It may also, for example, be incorporated into a cartridge or other structure, which can be removed and replaced with another filter cartridge or removed to allow the filter to be cleaned or replaced and then reinserted into the opening. A circuit 422 includes the electronics for controlling the operation of the fan and recharging battery 426, which is placed within the vent housing above the fan assembly. However, the battery could, alternatively, be located elsewhere, such as on either side or, if there are two batteries, on both sides of the fan assembly, or outside the vent unit on the facial guard system 200 or mounted on the retention system 240 for the facial guard system. Controls for operating the unit are located on the exterior of the vent housing 404. A button 428 can allow the wearer to turn the fan on and off. A USB port 430 is used to recharge the battery 426.

A centrifugal fan is used in the examples of the integrated fan and filter units 400 that are shown in FIGS. 14 to 17 instead of an axial flow fan. A centrifugal fan generates more pressure differential than a similarly sized axial fan and thus greater airflow rates for a given size of opening. It also generates greater suction (low pressure) at its opening to help to compensate for the impedance to airflow created by a filter over its opening.

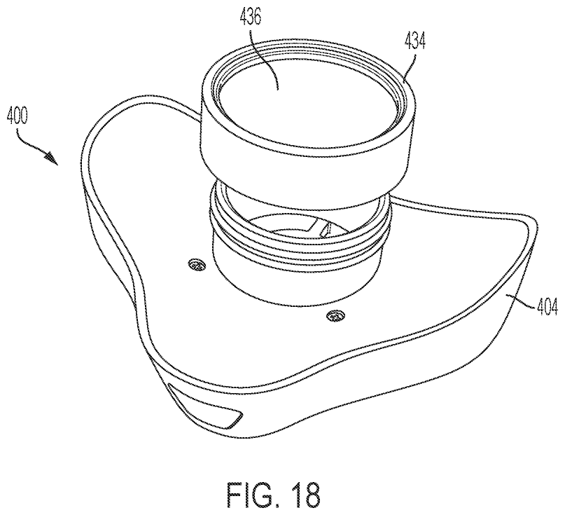

FIG. 18 illustrates an example of an integrated fan and filter unit 400 that incorporates in the vent housing 404 an axial flow fan assembly, which cannot be seen. Air is drawn in the underside of the unit, like the units shown in FIGS. 14 to 17, but it exits the fan assembly through an outlet 432 that is aligned with the opening and with the wearer's nose and mouth so that the exiting air stream flows directly toward the mouth and nose of the wearer. The unit with the axial fan can also be configured to attach to the face shield 202 by inserting the outlet 432 through an opening and securing it by attaching a cap 434, such as by screwing onto threads formed on the outlet. A filter 436 is mounted within the cap to filter the blown air before existing openings in the cap.

An integrated fan and filter unit may, optionally, incorporate a UV light at a position in or next to the stream of air to kill viruses in the air stream before entering the closed chamber. Systems for modulating temperature and moisture may, optionally, be incorporated where the upper or lower diaphragms are located. For example, the integrated fan and filter unit may, optionally, be adapted to function to control the temperature and/or humidity of the air being drawn into the closed chamber with a controller through the addition, for example, the capability of heating, cooling, dehumidifying, and/or humidifying the air within the closed chamber or passing through the unit, or both. The controller may, optionally, receive a signal from one or more sensors indicating the temperature and humidity of the air inside the chamber and/or outside the chamber. The filtration of the apparatus may also be graded based on efficiency and based on the size of the particles to be guarded against.

For each of the examples of the embodiments described above, an example of the filtering media for the diaphragms or filters for each of the vents is an N95-equivalent polytetrafluoroethylene (PTFE) with a 0.3 micrometer pore size. For example, a membrane filter made of PTFE that is laminated with polypropylene on one side to improve its strength and handling can be supported within the openings of the vents and relatively easily handled during installation and removal.

Referring now generally to all of the figures, a barrier used in the examples of facial guard systems 100 and 200 is made of relatively hard or rigid material and thus will tend not to transmit sound, which are vibrations or waves of varying air pressure caused by the vibration of the vocal cords. In fact, speech uttered by a wearer may echo within the closed chamber. Having a relatively large total area for all of filtered openings—for example, the diaphragms 126a and 126b of facial guard system 100 and filters in the vents 226a to 226d for facial guard system 200—mitigates this problem and will allow a wearer to be easily heard, especially as compared to wearing a mask, which muffles speech.

A facial guard system like systems 100 and 200 could be made with the barrier placed relatively close to the face. The barrier could also be contoured to conform to the face to reduce its overall size. However, doing so will reduce the volume of the closed chamber and thus the paranasal volume. It is believed that the paranasal volume can affect how easy it is to speak clearly. If the volume defined by the closed chamber 124 or 224 is made too small, such as by placing the barrier—the visor 102 or facial shield 202—too close to the face of the wearer, it can make it more difficult to speak clearly, like when wearing a conventional mask. The difficulty with clearly speaking when wearing a mask is likely due to resistance or impedance to the flow of air out of the wearer's mouth, and thus also past the vocal cords, which is caused by a relatively small paranasal volume between the mask and the wearer's mouth. The airflow is necessary to cause the vocal cords to vibrate. However, the facial guard systems like those of facial guard systems 100 and 200 can be made with a comparatively much larger, closed chamber 124 or 224, providing a much larger paranasal volume that is large enough for a wearer to feel as if they are speaking without a mask.

It is believed through observation that increasing the paranasal volume within the closed chamber increases the tendency of a wearer's speech to echo within the facial guard system, which is annoying to the wearer and impairs the intelligibility of the wearer's speech and tends to impede the transmission of sound to the environment, which also impairs intelligibility. It is believed, based on observation, increasing the total area of the filtered openings in the facial guard system so that the ratio of the total volume of the enclosed space to filtered openings is lower mitigates these problems. For example, the total area of the filtered openings to the environment is, in the illustrated embodiments, directly related to the total area of the filter diaphragms being used to filter the air. However, how much the size of the submaxillary and prefrontal openings can be increased is limited without increasing the overall size of the facial guard system.

To increase the total area of the filtered openings with substantially diminishing the ability of someone to see the wearer's facial expressions, and in particular their eyes and mouth, facial guard system 200 adds filtered openings on opposite sides of the facial shield 202. The lateral side filters 226c and 226d of the facial guard system 200 are examples of additional filter openings added to increase the total area of filtered openings without blocking the view of the wearer's eyes and mouth, at least by someone standing in front of or slightly to one side of the wearer. Thus, facial guard system 200 has a barrier and anchoring platform that define relatively large paranasal volume and have filtered openings between the closed chamber 224 and the environment that provide a large enough ratio of the total area of the filtered openings to the volume of the closed chamber to avoid echoes. The additional lateral or side filtered openings could instead or in addition be defined and supported by the anchoring base of a facial guard system, where it extends along the sides of the wearer's face.

The embodiments of a facial guard system described above, with a barrier or front shield, base, and vents, may be used or adapted for other applications.

Optionally, the filters used in any of the embodiments and examples described above are removable (or incorporated into a removable component such as a frame or cartridge) for sanitizing with O₃ perfusion or ultraviolet light radiation in a compartmentalized handbag or shoulder bag. The entire facial guard system may, optionally, be configured to be placed into such a compartment and be sanitized.

In each of the embodiments and the examples of each embodiment described above, the barrier—the visor 102 or shield 202—is made of a relatively rigid material and is, except as otherwise noted, made as a unitary or single piece. However, it can be assembled from pieces and multiple different types of material. For example, the barrier may, optionally, be adapted to incorporate corrective lenses at locations in which they are in a line of sight of the wearer or to function as a heads-up display. The corrective lens could be formed from the same material as the barrier and integrated with the barrier. Or, for example, openings in the barrier could be formed, into which lenses are inserted with a seal between each lens and edge of the opening, or the barrier could be formed with a support structure that holds the lenses in place without creating an opening or affecting their optics.

Depending on the use of the facial guard system, the entire facial guard or visor may be clear or tinted, a portion clear and a portion tinted. All or parts of it can be transparent, meaning either clear or tinted, but not opaque, so that it can be seen through. All or parts of it, such as the parts other than those made transparent, can be made opaque. For example, if used to treat sleep apnea, all of it or a portion of it located around the eyes can be darkened to reduce or block transmission of light. When embodied as personal protective equipment for a healthcare worker, it is preferred that at least the portion of the barrier in front of the wearer's eyes and mouth is sufficiently transparent so they can be seen by others to improve communication, with the remainder the same or with a different level of transparency, including opaque. That portion may be clear or tinted.

The foregoing description is of exemplary and preferred embodiments. The invention, as defined by the appended claims, is not limited to the described embodiments. The embodiments are, unless otherwise noted, nonlimiting examples and alterations and modifications to the disclosed embodiments, which may be made without departing from the invention. The meanings of the terms are, unless stated otherwise, intended to have their ordinary and customary meaning to those in the art and are not intended to be limited to specific implementations that are shown and described.

What is claimed is:

1. An apparatus configured to be worn on a person's head, in front of the person's face, comprising:
a solid barrier having a peripheral edge and a size that, when worn by the person, extends vertically from the person's forehead to below the person's mouth and laterally beyond each of the person's eyes, the solid barrier being transparent at least in front of the person's eyes;
a base that is configured to cooperate with the barrier to support the barrier at a position in front of and distanced from the person's face when the apparatus is worn and the base is pulled against person's head, the base being shaped to conform to a person's face and comprising a seal adaptable to create a seal along the peripheral edge of the barrier and the person's face when the apparatus is on the person's head, thereby forming an enclosed space in front of the person's face; and
at least one filtered opening that permits flow of air in at least one direction between the enclosed space and an environment outside of the enclosed space through a filter when there exists an air pressure differential across the filtered air opening while filtering particles of at least a predetermined size.

2. The apparatus of claim 1, wherein the base is configured to create, when worn by the person, a seal with the barrier, along its periphery, and a continuous seal with the wearer's face across the wearer's forehead, down along the person's zygoma, cheek, and jaw on each side of the wearer's face, and under the wearer's chin; and wherein the barrier and base cooperate to prevent substantial airflow into and out of the enclosed space except through the at least one filtered opening.

3. The apparatus of claim 1, wherein the filter is capable of blocking at least a predetermined percentage of particles entrained in air flows passing through a filter of the type for which the protection system is intended to protect against.

4. The apparatus of claim 3, wherein the particles being blocked by the filter include a virus.

5. The apparatus of claim 1, wherein the filter is comprised of a filtering media made of non-woven fibers that form a dense yet sufficiently porous interface through which air can flow while impeding passage of particles with a diameter of equal to or greater than 0.3 micrometers through the filter by trapping or otherwise blocking movement of particles through the filter.

6. The apparatus of claim 1, wherein the at least one filtered opening comprises a submaxillary filtered opening below a chin or jaw of the person wearing the apparatus when the apparatus is placed on the wearer's face and a prefrontal filtered opening.

7. The apparatus of claim 6, wherein the submaxillary filtered opening incorporates a fan for generating a pressure differential resulting in a flow of air between the enclosed space and the environment.

8. The apparatus of claim 7, wherein the fan is powered by a battery supported on the apparatus.

9. The apparatus of any one of claims 7, wherein the fan is comprised of a centrifugal fan.

10. The apparatus of any of claims 7, wherein the fan draws in air from the environment outside of the apparatus and blows a stream of filtered air into the enclosed space.

11. The apparatus of claim 10, wherein, when the apparatus is worn by the person, the integrated fan and filter assembly is configured and positioned to direct the stream of filtered air toward the person's nostrils.

12. The apparatus of claim 1, wherein at least one of a left or right side of the apparatus further comprises a lateral filtered opening.

13. The apparatus of any claim 1, wherein the barrier comprises rigid shield that is sufficiently transparent at least in front of the mouth and eyes of the person wearing the apparatus to allow for the persons eyes and mouth by another person directly in front of the person wearing the apparatus.

14. The apparatus of claim 1, wherein one or more filtered openings are formed by an opening defined within the barrier.

15. The apparatus claim 1 wherein the at least one filtered opening is formed by an opening defined within the base.

16. The apparatus of claim 1, wherein the base comprises an anchoring platform, the anchoring platform having a first portion with which the barrier forms a seal and a second portion configured to conform to the face of the wearing the apparatus to form the seal.

17. The apparatus of claim 16, wherein the second portion comprises a sealing surface that is supported by the second portion for displacement toward the first portion when the anchoring platform is pulled against the face of the person wearing the apparatus, and for generation of a return force that resists the displacement.

18. The apparatus of claim 16, wherein the second portion supports the sealing surface in a manner that allows the sealing surface to orient toward the face of the person wearing the apparatus when the anchoring platform is pulled against the face.

19. An apparatus configured to be worn on a person's head, in front of the person's face, comprising:
a rigid barrier having a peripheral edge and a size that, when worn by the person, extends vertically from the person's forehead to below the person's mouth and laterally beyond each of the person's eyes, the solid barrier being transparent at least in front of the person's eyes;
a base that is configured to cooperate with the barrier to support the barrier at a position in front of and distanced from the person's face when the apparatus is worn and the base is pulled against person's head, the base being shaped to conform to a person's face and form, when worn by the person, a seal along the periphery of the barrier, the seal continuous along across the wearer's forehead, down the person's zygoma, cheek, and jaw on each side of the wearer's face, and under the wearer's chin; and
two or more filtered openings, each of the filtered openings permitting air to flow between the enclosed space and the environment outside of the enclosed space through a filter that filters particles of at least a predetermined size, at least one of the two more filtered openings having associated with it a fan adapted to generate a pressure differential to create air flow through the filter between the enclosed space and the environment;
wherein the barrier and base cooperate to prevent substantial airflow into and out of the enclosed space when being worn by the person and the at least one fan is operating except through the two or more filtered openings.

20. The apparatus of claim 19, wherein the particles being blocked by the filter include a virus.

21. The apparatus of claim 19, wherein, when the apparatus is worn by the person, at least one of the two or more openings with the fan is configured to direct the stream of filtered air toward the person's nostrils.

22. The apparatus of claim 19, wherein the at least one of the two or more openings with the fan is positioned below at or below the chin of the person when the apparatus is worn by the person.

23. The apparatus of claim 19, wherein at least one of the two or more filtered openings is positioned to a left or right side of the person's eyes when the apparatus is worn.
